(19) United States
(12) Patent Application Publication
(10) Pub. No.: US 2012/0173381 A1
(43) Pub. Date: Jul. 5, 2012

(54) Process and system for pricing and processing weighted data in a federated or subscription based data source

(76) Inventor: Stanley Benjamin Smith, Fort Mill, SC (US)

(21) Appl. No.: 12/932,798

(22) Filed: Mar. 7, 2011

Related U.S. Application Data
(63) Continuation-in-part of application No. 12/930,280, filed on Jan. 3, 2011.

(51) Int. Cl. G06Q 30/00; G06F 17/00

(52) U.S. Cl. 705/26.5; 705/400

(57) ABSTRACT

A system and method for collecting handling processing and calculating values weights and prices for observations entered by one or a plurality of sources about one or a plurality of targets related to a researchable model or a theory or practice.

### BACKGROUND OF THE INVENTION

1. Field of the Invention

This invention relates to methods and systems for handling, weighting, and pricing data according to characteristics of targets and sources.

2. Description of the Related Art

There are many fields where it is desirable to be able to collect and analyze large amounts of sparse data; to organize and weight the value of the data, and to calculate and charge fees as data is included into a data source or a data supply chain. Immediate calculation and feedback regarding the value, quality, or price for data enables a researcher or other user to adjust a research design or to modify an experiment on the basis of the quality of available or accessible or affordable data as part of the management of the total cycle of research. Values and weights for sources and targets of data that are automatically included into calculated and actions upon the data enable a pragmatic informed approach to adjusting an experiment or research process and has broad and diverse potential. This system and method can be applied to any business process that accumulates sparse data and benefits from rapid adjustment in assessment of the quality of the data and prices to pay for the data as well as for feedback and notification cycles or other actions or events related to the data.

The lack of efficient, accurate and cost-effective methods for collecting, handling, scoring and paying for and reporting data is a problem that crosses many disciplines. Similar problems occur, for example, in outcome research for medical or social services, quality control systems in manufacturing, or research on drug interactions for pharmaceutical products.

For example, employers, such as businesses, police departments, schools, and the like, have a procedure for performance evaluation of employees. Often, however, performance information is collected in a haphazard manner. Sometimes there is no opportunity for input by actual observers of performance behavior. Sometimes there is no specification of performance standards or expectations which leads to inconsistent or unjustified performance ratings. Sometimes there is no method for accumulation of and unjustified performance ratings. Sometimes there is no method for accumulation of and calculations upon units of performance resulting in assignment of global or arbitrary final ratings. Sometimes there is a large gap in time between the event or the observation and feedback to employees about performance so neither appraisers nor employees remember the event(s) used to justify the appraisal ratings. In many cases, the sources of the data should be weighted differently to reflect the competencies or roles or interests or agendas of the source. In many other cases the target for the data or the subset of behavior being evaluated should be weighted differently to reflect the urgency or importance or impact of the target within the larger research or performance context.

Feedback mechanism for researchers or managers or participants in business processes vary, however; in most instances, if timely calculated or scored feedback on experimental or performance information is made available, informed corrective adjustments and behavioral changes can be made. Immediate, accurately proportioned and scored specific feedback will impact business process improvement and, therefore, impact cost and quality of service. If a researcher can anticipate the value of data based on its sources or targets and assign pricing schemas to that data, the data supply chain for the researcher will be rational and manageable. Postings to dashboards and pushing or pulling feedback to participants in data supply chains through “bots” or postings to devices that run computer readable code can be used as part of triggering processes for further actions in regard to data. Thus, the weighting of the data itself may become part of the assessment of threshold values for triggers or other decision tools and processes as these get posted to local or distributed or cloud housed data sources, to participants in a data supply chain or to a federated data source.

It is an object of the invention to provide a method for accumulating, weighting, and pricing data collection and calculation to increase efficiency.

It is also an object of the invention to provide a method for rapidly designing information gathering and research routines for sparse as well as dense data, to continuously capture information and research observations, to immediately calculate the value and impact of the information or data, and to provide feedback based on the information and research observations.

It is a further object of the invention to provide a method to increase the efficiency and decrease the cost of accumulating and handling information and scoring and applying this information.

It is further an object of the invention to categorize the data collected so it can be applied to multiple fields of inquiry with little or no loss in statistical validity.

It is further an object of the invention to accumulate, organize, and distribute the data collected so cross-organizational benchmarking can be easily and efficiently implemented and a data supply chain or federated data source can be developed.

It is further an object of the invention to provide a method for rapid feedback and distribution of data and reports on the data to users for immediate application to improve processes, behavior, outcomes, or research results.

It is further an object of the invention to provide a method for weighting and pricing sources and targets of observation or research.

Other objects and advantages will be more fully apparent from the following disclosure and appended claims.

### SUMMARY OF THE INVENTION

The invention herein is a process for capturing and assigning a weight or value and a price to sources of data or information as well as to the target subjects or topics about which and upon which observations are made and data is captured to use to drive further events and actions if folded into triggers or thresholds within data sources on local servers or participating in a data supply chain or as apart of a federated data source. In particular the invention implements a system and method to collect, group, handle, weight, calculate, and price data. In particular, the invention provides a method for collecting and handling observations related to a researchable model or a theory or practice, such as biosynthesis, a sales process, a production assembly line, performance appraisal, cost accounting, outcome measurement, hiring and selection, project management, or other process.

Other objects and features of the inventions will be more fully apparent from the following disclosure and appended claims.

### BRIEF DESCRIPTION OF THE DRAWINGS

FIG. 1 is a schematic diagram of how the invention may be used to structure a research process.

FIG. 2 is a schematic diagram of how components of the invention link together.

FIG. 3 is a schematic diagram of the preferred organization of the components of the invention herein.

FIG. 4 is a schematic diagram of an overview of the calculation sequence and method of the invention herein.

FIG. 5 is a schematic diagram of detailed steps of the calculation sequence and method of the invention herein.

### DETAILED DESCRIPTION OF THE INVENTION AND PREFERRED EMBODIMENTS THEREOF

The present invention is a method and system for capturing information, weighting and pricing captured information, using calculated captured information to provide feedback, and applying and distributing that feedback. In particular, the invention provides a method for collecting and handling observations related to a researchable model or a theory or practice.

Because the various components of the invention, once defined, can be easily applied to data from any source, and because these components are interrelated and can be redefined at the user's option or redefined automatically, the process and system of the invention are extraordinarily flexible and enable rapid corrective adjustments in experimental design, data accumulation, data analysis, and price calculation. The ability of the system and method to generate one or a plurality of calculated values that can be used to trigger further actions or events through computing devices acting as servers and able to process computer readable code enables the automation of research processes even for sparse and sporadic data collection and input.

Following are a list of definitions of terms used in this description of the invention in the order they are introduced in this description:

| | |
|---|---|
| Subscriber | An organization or a researcher with the right to use the computer |
| | readable code in at least one application cluster. A user of the |
| | invention. A contributor to a data supply chain or federated data |
| | source that also has the right to use the invention or the computer |
| | readable code that implements the invention in at least one application |
| | cluster through any device or plurality of devices that can process |
| | computer readable code.. |
| Root element | The fundamental and essential label for a factor or feature that is |
| | potentially an object of research and about which data or observations |
| | may be collected and to which a value or price may be assigned. |
| Algorithm and | The mathematical construct that operationalizes the design of the |
| Roll-up | invention by calculating and apportioning weights, values, prices, |
| Algorithm | relationships of input sources, and other components and features of |
| | the invention. |
| Application | The field, discipline, subject, topic, area, business process, or set of |
| cluster | functions that may be the object of research. |
| Hub | An entity with a relationship to an element that is a subunit of an |
| | application cluster. A unit that may be a source and/or target of |
| | observations within an application cluster and to which booklets can |
| | be attached |
| Observations | Data, comments, information, or ratings about hubs. |
| Atoms | Discrete data entries or objects that constitute an observation with a |
| | specific structure defined through the invention. |
| Element | The label applied to a root element based upon the jargon, language or |
| | context determined by the application cluster that is being researched. |
| Booklet item | The label or phrasing of an element relevant to the research topic of |
| | the application cluster in a specific position in a “booklet” (see |
| | definition below). |
| Input Value | The permissible format or structure for an observation, such as |
| | numeric; Boolean—present or not present; scalar—0 to 100%; |
| | typological—with or without another amino acid attached, etc.. |
| Booklet | A list of elements organized in a hierarchical tree structure. |
| Coefficient | The relative weight of a given booklet item as compared with other |
| | booklet items at the same level in the tree in a booklet to be used to |
| | adjust pricing and other calculations. |
| Level | The location within a booklet's hierarchical tree for a booklet item. |
| Hub category | A class or type or group of hubs that are in a consistent structural or |
| | sequential relationship in an application cluster |
| Source | The hub that enters observations about another hub. |
| Target | The hub that is the object of an observation from another hub. |
| | Note: A hub can be both a source and a target. |
| Input source | Relative impact of the source of the observing hub upon the target hub |
| weight | for apportioning calculation of part of the observation by the roll-up |
| | algorithm and for establishing pricing according to the weight or |
| | reputation value or impact assigned to the source. |
| Pivot hub | The anchor of an application cluster. The hub category about which |
| category | results are calculated and feedback produced. The focus for the |
| | research hypothesis of the application cluster. |
| Pivot hub | Any hub belonging to a pivot hub category. A hub that becomes the |
| | object of analysis and calculations. |
| Publisher | The provider of computer readable code to accomplish the method of |
| | the invention with at least one application cluster. The provider of |
| | training in using the system. The organizer and maintainer of the data. |
| | The owner of the invention and the federated data source of all root |
| | elements, booklet items, and other data for benchmarking and |
| | research. The manager or owner of the conduit for distribution of data |
| | to participants in a data supply chain. |
| Client | A sub-set of a subscriber that uses at least one application cluster. |
| Isomorphism | The property of the invention that enables a user or subscriber to |
| | configure the screens and labels to have the “look and feel” of a |
| | specific and unique research design or business process, while the |
| | underlying structure is universal and common to all “morphs”. |
| Position | The precise place within the hierarchical structure of a booklet where |
| | an element label is placed so the roll-up algorithm can identify its |
| | parent level and place in the sequence of its sibling items. |
| Booklet item | The value to be used for a given element if no score was entered for |
| default value | the corresponding booklet item. In a pricing calculation, the default |
| | price to be assigned to a booklet item. |
| Booklet item | The proportional weight to be attributed to the input value for a |
| weight | booklet item compared with all other booklet items at the same level |
| | in the booklet tree. In a pricing calculation, the pricing adjustment to |
| | apply to a booklet item. |
| Booklet weight | The proportional weight to be attributed to the calculated results for |
| | each booklet attached to a given pivot hub. In a pricing calculation, |
| | the pricing adjustment to apply to the calculated results for a booklet. |
| Cluster default | The value to be used in the calculation for a given booklet item if no |
| value | input value was entered and no default value was set up for the |
| | booklet item. In a pricing calculation, the default value to be used to |
| | adjust prices for booklet items. |
| Missing | The booklet level at which the default value or price or adjustment is |
| replacement | to be inserted if no input value exists at that level or below. |
| level | |
| Roll-up level | The level at which roll-up calculations stop. |
| Display level | The level at which weighted averages from several different input |
| | sources are calculated and displayed. |

Because data accumulated through the invention is attached to an evolving list of “root elements” (see definition above) that are relevant across activities, industries and disciplines, the process and system of the invention allows for cross-correlations between any dimensions in any field. This enables benchmarking research to be performed rapidly and easily. The steps of the present invention are best carried out through a number of customizable computer screens or graphical user interfaces that enable users or subscribers to accumulate, route, research, and calculate data for a specific application. A unique roll-up algorithm (see definition above) is used in the calculation process, a detailed example of the use of which is provided herein.

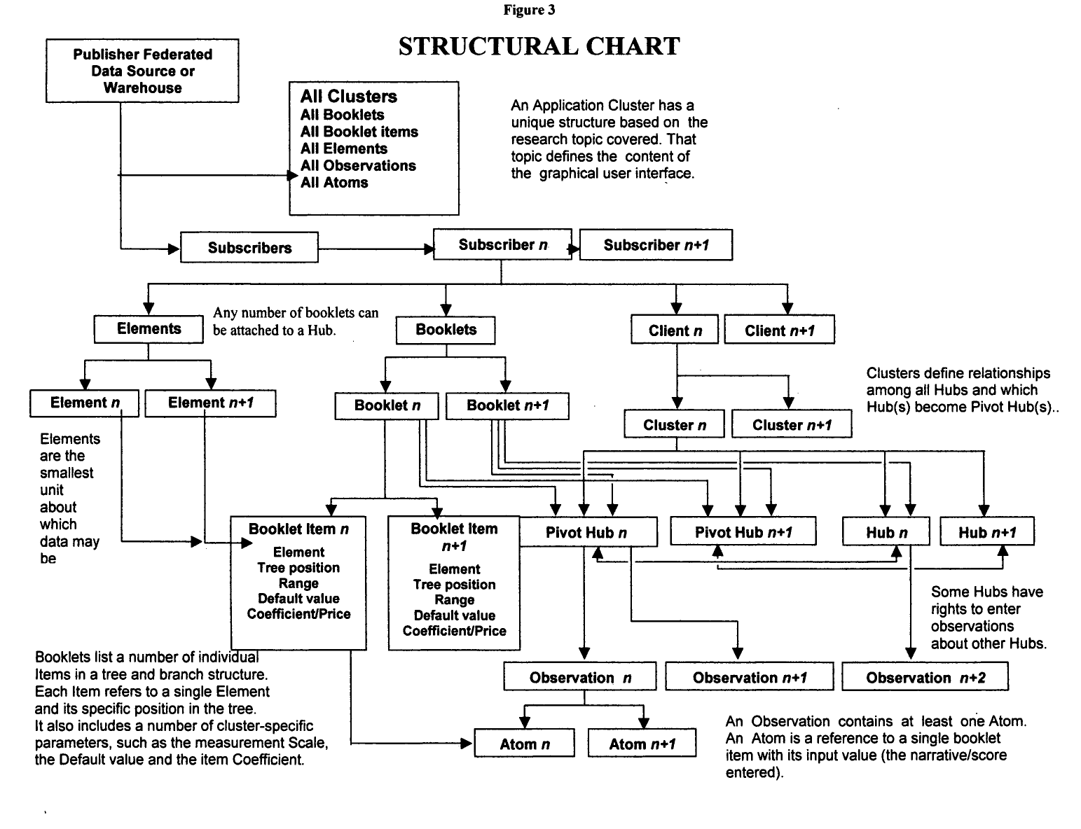

Prior to providing more details on the invention, following is a discussion of the invention where important terms as related to this invention are defined (see FIG. 3).

As used herein, the term “application cluster” (see definition above) means the business process or research process to which the invention is being applied. The application cluster enables the accumulation of observations about a definable set of “hubs” (see definition above) by or about which data can be created that are in identifiable relationships to one another, for example; machine for, catalyst for, supervisor of, therapist to, patient of, design stage of.

The application cluster provides the specifications for the behavior of the information handling process. An application cluster is operationalized by a set of computer screens and screen labels. These screens and labels have selectable items or sets of items that enable entry or review of observations.

“Observations” (see definition above) are data or comments about hubs defined by the application cluster, which in the method of the invention are entered into the computer by an authorized user or subscriber or are accumulated from data sources across servers and devices associated through the Internet or other set of servers, such as those offered by vendors of “cloud” computing services. Each observation contains one or more “atoms” (see definition above), which are the discrete data entries that constitute the observation. Each atom in the invention must be defined by two criteria. First, because data collection is essentially accumulation of information about “elements” (see definition above) being researched by an application cluster, e.g., how long has the person been employed, what is the mass of a compound, how much time was involved in the sale, etc., each atom is attached to one of the elements being researched by that application cluster through a booklet item (see definition above). Second, the atom is attached to the value entered by the user or subscriber for the booklet item. This value is called the atom's “input value” (see definition above).

When creating and processing lists of elements or processing fields being contributed to a data supply chain into booklet items, the researcher uses screens in the application cluster setup routine to determine the style or type of input that can be entered or collected by the person making the entry or accessing the server housing the computer readable code. For example, the researcher determines any of a number of input value types for an experiment on lysine use in a cell, such as numeric; Boolean—present or not present; scalar—0 to 100%; typological—with or without another amino acid attached; or many other possible options.

As used herein, a “booklet item” is both the phrasing or label of an “element” that is relevant to the research topic of the application cluster and is placed into a specific position in a “booklet” (see definition above). The booklet is a list of element labels organized in a hierarchical tree structure. A booklet item is the element label along with its location in the tree and branch hierarchy of a booklet. The relationship between each atom and its booklet item links a particular value with a particular element through the element label.

The information handling process can thereby locate and correlate all atoms related to the same booklet item. Each booklet item may also be given a set of properties; for example, a default value, a possible range, a financial value or price, and the coefficient's (see definition above) relative weight as compared with other booklet items at the same level in the tree as discussed below. The type and properties of booklet items within booklets can be defined by the user or subscriber or the provider of the invention as needed. This enables the invention to organize observations for calculation and make the calculations immediately available for in-course adjustment by the researcher or subscriber or to trigger server actions in response achievement of thresholds values. The same calculations are also available for data management that requires long-term research and data handling for multiple datasets.

A booklet as used herein, is a list of element labels arranged into a tree and branch hierarchy about a given subject or content area, for example, job descriptions or functions, equipment specifications, personal or individual demographics, questionnaire items, candidate selection criteria and the like. Each member of an element label list in the hierarchy takes on the properties of a booklet item as its “position” (see definition above) in the hierarchical tree structure is set. As defined herein, the “level” of a booklet item in the hierarchy within a booklet is based on where the booklet item is in the hierarchy. Thus, booklet items at the highest level in the hierarchy are said to be at level 1, and there are no higher (parent) booklet items in that booklet. Each level 1 booklet item has zero to many “children” booklet items at level 2, and so on, through levels 3, 4, etc., as is deemed appropriate for the type of information being handled and the exigencies of the situation.

As an example of the hierarchical arrangement of the booklet and booklet items of the invention, a booklet related to job performance might have several different major required job functions associated with the job, each of which functions might have one or more aspects that may be separately followed and analyzed. One way of looking at booklets is to think of the characteristics of the particular subject being outlined in a standard outline format. The extent of the specificity of these tree-structures, in other words, the number of levels, is limited only by practical considerations.

An application cluster can use any number of booklets and any number of booklets can be attached to a hub. For example, employees can have duties, goals, and/or project booklets in a performance appraisal cluster; a chain of production can have quality, process, resource, and/or time management booklets. Subscribers can assign weights to booklets to account for the relative importance of the various booklets attached to a hub. For example, the quality booklet attached to a chain of production hub could have a weight of 0.5, while the weight of the process booklet is 0.2 and the time management booklet is 0.3. Similarly, a pricing schema can be associated with each booklet based upon the weight assigned to it or upon other criteria with entries into the quality booklet being assigned 0.5 cents, the process booklet being assigned 2 cents and the time management process 0.9 cents.

The capability of the invention to assign weights or values and prices to individual booklet items as well as booklets themselves enables the user or subscriber to put a precise emphasis on key aspects of the content area that is researched. Weights can be used to apportion prices as well as prices being adjusted or modified over time to allow the research design to evolve as the emphasis shifts with the changes in the research or the organization or the priority or value of the data associated with items and booklets.

As defined above, an element is a unit about which data may be gathered or calculated. Examples include the mass of an object, the amount of lysine in a cell, the preference of an individual to dominate others, the rating of an employee on a work assignment, and an employee's home telephone number. An element is independent from booklets: it does not belong to a hierarchy but is listed with all other existing elements in a data source or “element list” from which a subscriber can pick, modify or create element labels to be inserted as booklet items in booklets.

Therefore, booklet items are created from elements and the labels assigned to those elements and placed in a hierarchy within a booklet. For example, in a performance appraisal cluster, the element “Performs regular checkups” can become a booklet item in a “Mechanic” booklet, a “Safety Officer” booklet, or a “Police Officer” booklet. The crucial difference between a booklet item and an element is that elements are context-independent while booklet items have a context, which is defined by the booklet.

As the invention is used and the number of booklets increases, each element gets linked to a growing number of booklet items. This design enables research to be done on elements, not only booklets items, thus allowing for cross-correlations between booklets, between content areas within a given application cluster, across application clusters, and across research or business processes. As an example, information about the element “respond to customer requests” can be used for research on receptionists, engineers, and department heads; or information about that same element in a performance appraisal cluster can be used for research in a quality management cluster.

The use of root elements also enables cross-industry research and benchmarking. Information gathered in a given industry can be used for research in another industry. The invention links each element to a single root element, which is the generic expression of that element. For example, “budget knowledge” is the root element for the element “develops a budget” used in a performance appraisal application cluster. In a job classification cluster, this same root element might be expressed as “budget experience”. A root element can cut across activities, industries and disciplines. A root element can therefore have several elements linked to it, each of which is expressed in a discipline-specific style, jargon, or language. In other words, all elements may have multiple phrasings that allow them to have the “look and feel” relevant to the particular application cluster.

This unique architecture of the invention ensures data cleanliness and, by design, makes data on root elements readily available for benchmarking studies, with minimal data cleaning or organizing and rapid reporting. The link between root elements and elements can be established by the subscriber and/or by the “publisher” (see the definition above). Elements and root elements are listed in the same element list, functioning as the central or federated data source gathering all research items across application clusters and across “clients” (see definition above). The status of an element evolves into various stages of validation as data accumulates about it through implementation of the system and methods shifting the status from hypothetical (i.e., insufficient numbers of observations for this element for a statistical analysis to be run on the data to confirm validity,) to validated as statistical operations and standards of validity get performed and the statistical target level set by the researcher or research design is reached.

To reiterate, the information handling process of the invention facilitates the validation of root elements through correlation of observations from different booklets, insofar as their booklet items refer to the same root element. Research is possible across booklets.

As defined above, a hub is determined by the application cluster, and is an entity by or about which observations can be created. A single position, a single department, a single enzyme, a single car, a single user or subscriber, any entity that plays a role in a given business or research process can be designated as a hub. When hubs are grouped into classes, they become a “hub category” (see definition above) Thus, there are various categories of hubs, for example; the position category, department category, enzyme category, and so on. A hub may be a source and/or target of observations within an application cluster and to which booklets can be attached. A hub entering an observation is the “source” (see definition above) of the observation, while the hub about which the observation is entered is the “target” (see definition above) of the observation. A hub can be both the source and the target of an observation; for example, an employee enters an observation about herself. Hubs can have any number of booklets attached to them, containing the booklet items that are connected to elements that are part of the field of inquiry relevant to the application cluster.

Examples of hubs and related booklets are:

| Hub | Booklet |
|---|---|
| Equipment | Specifications |
| Manager | Goals |
| Personnel or other employees | Job description |
| Patients | Medications |
| Manufacturing processes | Welding specifications |

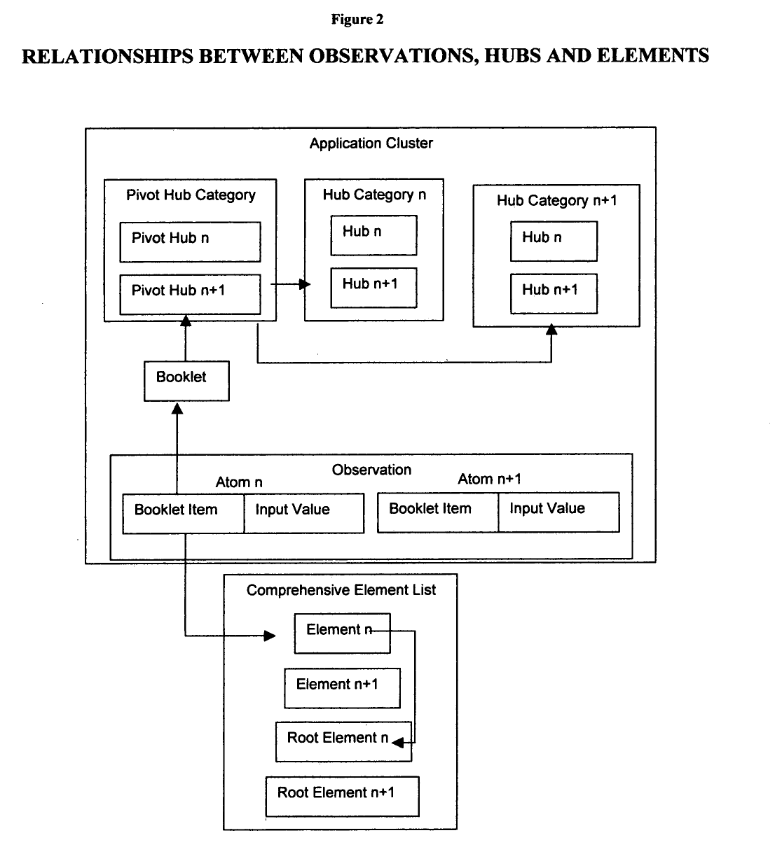

When an observation is entered about a research question, the observation retains the identity of the source and target hub. Each atom is related to the hub that created the observation and the hub about which the observation was written. The type of relationship that existed between the two hubs at the time of the observation is also retained. As described above, the observation also retains atoms that have been entered. Thus the information in each observation completely specifies the context, through the hubs and the relationship between them, and the content, the atoms, of all data. There is no requirement for observations to have similar structures, but rather the atoms present in each observation are entirely dependent on the booklet items to which the atoms relate. Because of this design feature, the information handling process of the invention can thereby research elements by source hub, target hub, or type of relationship. See FIG. 2 that follows for a schematic of the relationship between hubs, atoms, booklets, and elements.

A hub can also be assigned a weight or a price for observations that it is a source for. This is called the “source input weight” (see definition above) and enables the impact of an observation to be retained and scored by the algorithm based on the relative impact or reputation or value assigned to the source of the observing hub upon the target hub of the observation. An example of the practical application of this feature is the differential weighting that might be assigned to input from a trained observer versus an untrained observer. The researcher may determine that the input from the trained observer is four times more accurate or four times more valuable than that from an untrained observer. The researcher might then decide that four observations from untrained observers might be equivalent to one observation from a trained observer and weight or price observations from these two hubs on identical booklet items to reflect this difference.

To reiterate, one can evaluate all atoms of data written by or about any hub based a) on the related booklet items, b) the hub itself, c) the hub's booklets, d) the hub's relationship with other hubs, and e) the application cluster to which the hub belongs through a hub category.

The relationship between each hub and the booklet(s) related to it specifies the behavior of the information handling process when operating on the hub in a specific application cluster. Likewise, the relationship of the hub and its booklets specifies the information that can be gathered about the hub. Only one category of hub, the “pivot hub category” (see definition above), can be the object of research for a given application cluster. For example, “positions” is the hub category that is the object of research in a performance appraisal cluster; “steps” is the hub category that is the object of research in a cluster that tracks through a process; “employees” is the hub category that is the object of research in a goal management cluster.

The pivot hub category is the anchor of an application cluster: It is the category about which results are calculated and feedback produced. In effect, the pivot hub category serves as the framework for the research being performed through the application cluster; for example, for a cost accounting application cluster: what are the proportional costs of this configuration of resources where the pivot hub equals “resources;” for a performance appraisal cluster: what are the strengths and weaknesses of this employee in this position where the pivot hub equals “position.”

A hub category can be the pivot category for a given application cluster and simply a hub for another application cluster. For example, the pivot hub for a performance appraisal application cluster is usually the job or position, and the job or position is also the pivot hub for a job classification application cluster—but the pivot hub for a quality control application cluster is the stage in the quality cycle that is being measured. Some of the same hubs; in this case employees, may be entering observations, but the pivot hub is different.

Any hub belonging to a pivot hub category is called a pivot hub. In other words, the pivot hub is a hub that becomes the object of analysis and calculations.

The invention uses three types of relationship between hubs. These three types of relationship are so generic that they apply to any system that can be studied; whether it is organic, inorganic, or conceptual. Hub relationships define the rights and entitlements of hubs to and with one another. These may be viewed as a diagram or chart that defines the levels of hierarchy and the directionality of vectors in a system. Thus, an example of a one-way vector is where the manager directs the employee, and a two-way vector is where peers exchange information with one another. A hub can also be a source and a target of an input, for example, where an employee appraises himself. The three possible types of hub relationship are:
a) inclusion, where a hub (i.e., a neighborhood or department) includes one or more other hubs (i.e., street corners, or divisions);
b) assignment, where a hub can be assigned to one or more other hubs (i.e., an employee assigned to a position); and
c) entitlement, where a hub can be the source or target of some action by another hub.

The latter relationship includes types of possible action: 1) information, where the hub is subject to being a source or target of accretion or accumulation of information, facts or features without weights or scores; for example, a series of police officers enters narratives about a hub that is a particular street corner, 2) influence, where a hub is subject to being the source or target of an influence, weight or score that can change its nature or composition or characteristics; for example, a series of police officers enter scored observations that cumulatively change the status of the hub that is the particular street corner, and 3) decision, where the hub is subject to being the source or target of a decision about it that changes its nature or composition or characteristics; for example, a police sergeant decides to take action upon the accumulated information in the narratives provided by the police officers.

Because all application clusters are built on the same design using hubs, relationships, booklets, booklet items, elements, and root elements, regardless of the field and process involved, the invention can easily convert screen labels and other features of graphical user interfaces from one application cluster to another. By simply translating the labels used by an application cluster to designate hubs, relationships, and booklets into the specific language or jargon of another field or process, the set of computer screens can be cloned into a different application cluster with no structural design changes and only minimal screen customization.

As a result of the computer readable code and the graphical user interface, the set of screens and menus that are presented to the user or subscriber to the invention can handle any business or research process. This is in contrast to current computer readable code configurations that are designed to serve only one or a few applications. The organization of booklet items, elements, and root elements in the invention also makes the data itself readily researchable across languages, dialects or jargons. This level of isomorphism, including both the computer readable code, the graphical user interface, and the researched data, is unique to this invention.

To further describe the benefit and application of isomorphism. It enables the substitution of one set of descriptors in a field of enquiry, study, research or business practice to another field. For example, a performance appraisal cluster and a job classification cluster both use booklet items from the element list that have root elements in common. For performance appraisal, the booklet item for an Accountant 1 hub might be “makes accurate general ledger entries” and for job classification of an Accountant 1 hub, the booklet item might be “knowledge of general ledger procedures”. The root element for both application clusters may be “general ledger competence” and a researcher can compare the number of observations of “general ledger competence” in performance appraisals to determine how important it might be to include “knowledge of general ledger procedures” in an Accountant 1 position description. If a training application cluster is added later and also has a root element of “general ledger competence” stated as “general ledger refresher training course”, then the training official can determine which job role needs the training (Accountant 1 or Accountant 2) and also which particular employees need the training.

The use of the invention is based on either a publisher-subscriber relationship between the licensee of the invention and the subscriber (see definition above) or upon a an agreed upon data exchange relationship which we have called the “data supply chain.”Both of these type of business relationship maximize the amount of information available for analysis using the method herein. The “publisher” (see definition above) is the licensed vendor of the invention, who provides the computer readable code to accomplish the method of the invention with at least one application cluster, provides training in using the system, organizes and maintains the data, and enables distribution of the data to participants in a data supply chain or cloud housed data source or federated data source. A “subscriber” is an organization or a researcher who purchases the right to use the computer readable code in at least one application cluster.

Each subscriber may have several “clients” (see definition above), who are sub-sets of a subscriber and that use at least one application cluster. The subscriber to an application cluster entitles a hub category and individual hubs to make entries into the computer readable code of observations about any booklet item relevant to that application cluster. For example, a hub can enter observations about a stage in quality cycle (quality management application cluster) and observations about the performance of a supervisor (performance appraisal cluster), but another hub can enter information only about the subordinate's performance. A graphical user interface can be tailored to hub to provide access to the computer readable code and to select from menus that open the booklet and display the appropriate booklet items to enter observations or change the status of booklet items in a structured and ordered fashion.

Using standard encryption technology and data transport utilities, the computer readable code provided to implement the method of the invention ports non-confidential information between subscribers, and publisher on any devices that can run computer readable while maintaining the security of the information. Subscribers can choose to tag confidential fields and to entitle the publisher to serve as a warehouse for data ported into the publisher's computers from their site.

As subscribers accumulate observations about the elements and root elements in the element list through their booklets, the observations are uploaded to the publisher's data warehouse or data supply chain. Other subscribers also upload observations about the same elements from identical or similar booklets to the data warehouse. As the accumulated observations on elements undergo statistical analysis and fine-tuning, they are modified for greater validity and may be, depending on authorization and subscription rights, downloaded back to the subscribers with better wording and stronger statistical relevance. For example, data from only one police department would not necessarily provide a sufficient sample size or cross-section of police-related performance events to inform a decision, but if 100 police departments all use the same elements to appraise their patrol officers, the analysis of the data from all the departments might indicate that some elements need to be replaced, reworded, scored differently or changed.

In one operation of the invention herein, depending on the agreement of the parties, subscribers may purchase a license to an application cluster with a specified number of attached booklets. The subscriber may also purchase rights to additional application clusters and to add additional sub-sets of their system that are their own client, such as a large corporation with multiple national divisions. Subscribers in the preferred method of the invention may pay consulting fees for the configuration, installation, design, and service and/or maintenance of the computer readable code, and a licensing fee for use of the computer readable code. In another operation of the invention herein, the owner of a data source may agree to provide access to one or a plurality of data sources on their server to be folded into the operation of the invention. The various sources of the data would carry adjusted or apportioned weights or a values or fees and the data fields or objects would also carry a adjusted weights or values or fees. Computer readable code will attribute values both to sources and targets that correlate with those already in place within the application cluster or a graphical user interface is provided to facilitate the assignment and collation and weighting and pricing of the sources and the targets of the elements.

Subscribers may subscribe to updated items/elements and modified booklets just as one would subscribe to a magazine or a newspaper. Benchmarking results and reports regarding differences among subscribers and their clients can also be purchased on a subscription basis. As new application clusters are developed along with their hubs, elements and booklets, subscribers can choose to subscribe to the additional application clusters and have these seamlessly and effortlessly downloaded into their network servers or other computing devices.

By design, application clusters run in an integrated fashion, allowing users to expand the use of the invention to any number of business or research processes with little setup work; for example, a job description and a classification and compensation application cluster can run simultaneously with an employee selection application cluster and with a performance management and appraisal application cluster. The data collected in one application cluster is readily available, if needed, for the other clusters.

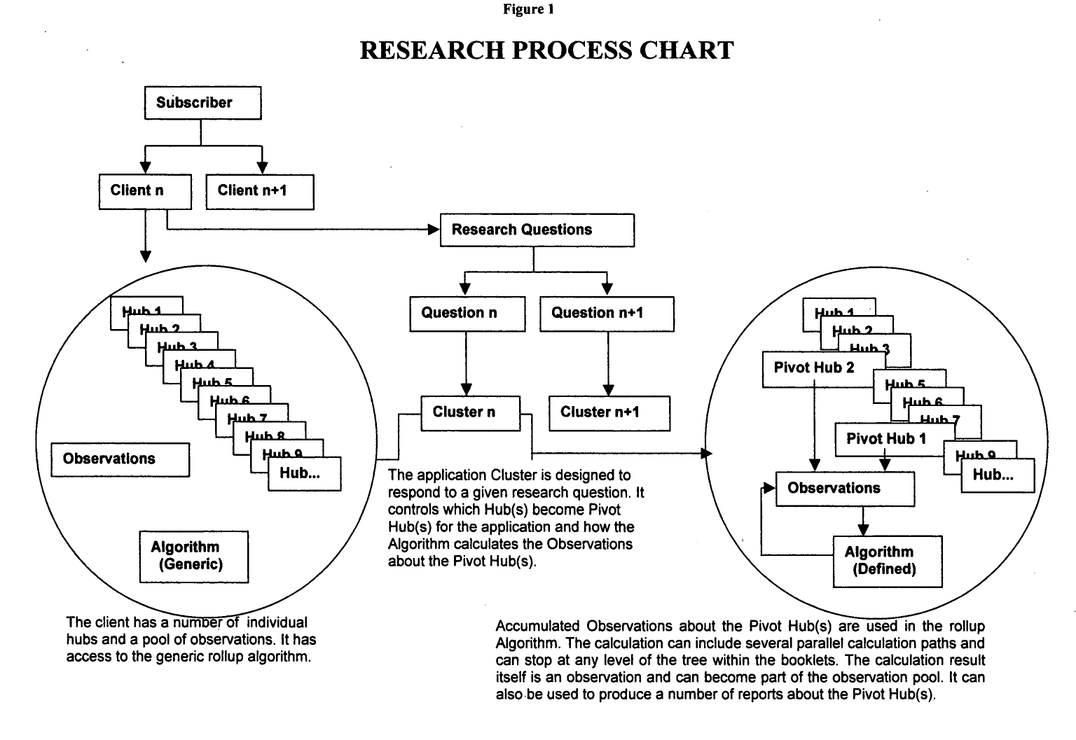

Referring in greater detail to the Figures, FIG. 1 shows how the invention structures a typical research process. A subscriber provides one or more clients with the ability to use computer readable code that implements the use of the method of the invention. Each client formulates research questions that an application cluster will be used to research.

In order to design the application cluster, publishers create or rename hub categories, structure, label, and define the relationship types, and determine what set of access and data entry rights are needed for each hub category. They then rename computer screen labels to be used in the graphical user interface and determine the pivot hub category that will be the target of observations and feedback for that application cluster. They also build booklets to be attached to each pivot hub and set up booklet and booklet item weights. Finally they set up the calculation algorithm parameters and pricing parameters (see below) in order to provide the client with the measurement they need. Once these steps have been completed, the new application cluster is uploaded to the client site and ready for use. From that point, the client can accumulate observations, produce reports, and develop new booklets as needed.

The calculation algorithm of the invention is a unique mathematical method that takes advantage of the unique structure of the invention to calculate values and prices from a number of observations associated with tree-structures or outlines made of booklet items. To keep the following description of the algorithm simple, all examples will be drawn from a performance appraisal application cluster. Note that the term “weight” in the description below is also intended to include prices or fees charged or paid and that the algorithm is rolling up costs as well as the impact of observations for purposes of research.

The algorithm calculates from the bottom up: it retrieves the input values for the booklet items at the lowest level of the tree (level n) and averages them proportionately by applying the booklet item weights if assigned, or distributing the weight evenly among all booklet items at this level if no specific weight was given. This generates the calculated values at the next level up (level n−1). The algorithm then averages this first series of calculated values proportionately, generating the next level values (level n−2) and so on, until the level at which the client sets for the final result is reached. Because of this step by step calculation from the bottom up, the algorithm is called a “roll-up algorithm”. When several input sources are used to enter observations about pivot hubs, the roll-up algorithm performs the roll-up calculation described above in parallel for each input source, and merges them at the level where the client needs consolidated results showing the average from all input sources (see algorithm example below). A number of client-defined parameters control what is calculated and priced and how the results are displayed for a given application cluster. A number of these parameters are set up, as discussed previously, when the booklet is created:

The “booklet item default value” (see definition above) determines the value to be used for a given element if no score was entered for the corresponding booklet item, such as 2.5 on a 5 point scale.

The “booklet item weight” (see definition above) determines the proportional weight and price or fee contribution factor to be attributed to the input value for a booklet item compared with all other booklet items at the same level in the booklet tree, such as 25% of the total weight or price for that level.

The “booklet weight” (see definition above) determines the proportional weight and price or fee contribution factor to be attributed to the calculated results for each booklet attached to a given pivot hub, such as 0.3 for a “goals” booklet and 0.7 for a “functions” booklet.

All other calculation parameters are set up when the cluster is created:

“Input source weight” (see definition above), as previously described, determines the proportional weight or price or fee contribution factor to be attributed to each input source for a given pivot hub, such as 0.9 for a supervisor and 0.1 for a peer.

“Cluster default value” (see definition above) as used herein is the value to be used in the calculation for a given booklet item if no input value was entered and no default value was set up for the booklet item.

“Missing replacement level” (see definition above) as used herein is the booklet level at which the default value is to be inserted if no input value exists at that level or below. A missing replacement level of “1” replaces missing values (no observation retrieved for the booklet item and the items below) with the default value chosen by the client only at level 1 in the booklets. A missing replacement value of “3” replaces missing values with the default value at level 3 in the booklets. If a default value has not been assigned to the booklet item by the client, the cluster default value is used (set by the client at the cluster level, see definition above). The cluster default value is sometimes mid-range if such a value is considered a typical score, or may be any other value as is appropriate for the application cluster (e.g., in biological research if there is no observation, an appropriate default value would be likely to be zero), or as is considered useful for the particular application.

“Roll-up level” (see definition above) as used herein is the level at which roll-up calculations stop. The algorithm can roll-up several booklets (roll-up level 0), or roll-up only to a given booklet level (roll-up level 1, 2, . . . ). In the first case, an average value for all booklets attached to a pivot hub is produced. For example, the average value for the “job duties booklet” and the “goals booklet” attached to an accountant I position (pivot hub) is calculated for Joan (hub) who is an incumbent in that position. This enables the client to compare Joan with other employees. In the second case, an average value for all booklet items at the roll-up level in the booklets attached to a pivot hub is calculated. For example, for a roll-up level of 1, the average value for “performs general ledger entries” and “maintains the filing system”, the two level 1 booklet items in the “job duties” booklet attached to the accountant I position is calculated. To do so, the algorithm rolled up all level 3 booklet items, then all level 2 booklet items below each of the two level 1 booklet items. The same thing is done for the level 1 booklet items in the “goals booklet”. This enables the client to compare the results for specific booklet items across employees or across departments.

“Display level” (see definition above) as used herein is the level at which weighted averages and accumulated fees or prices from several different input sources are calculated and displayed. A display level of “1” merges all input sources such as the supervisor, the peers, the self, and the subordinates of a single employee at level 1 in the booklets attached to the position that the employee occupies. The display level provides the user with a detailed analysis of the results for the given pivot hub. It may also be appropriate, depending on the application cluster, to calculate more than one result by doing calculations on multiple sets of data in parallel. The calculation result itself is considered an observation and becomes part of the observation pool, and can also be used to produce a number of reports about the pivot hubs (macro level research). Implementation of this capability may also serve to trigger server events or actions that are folded into the operation of a data supply chain or a federated data source.

The explanation of the algorithm indicates the complexity and nuance of calculations that may be managed through the invention. Simpler calculations external to the roll-up algorithm are expected to be part and parcel of many application clusters and some application clusters may not implement the roll-up calculations at all, but utilize alternative computational or calculation methods. An application cluster that does not implement the roll-up algorithm may retain and implement the booklet structure and data accumulation and posting methods described herein.

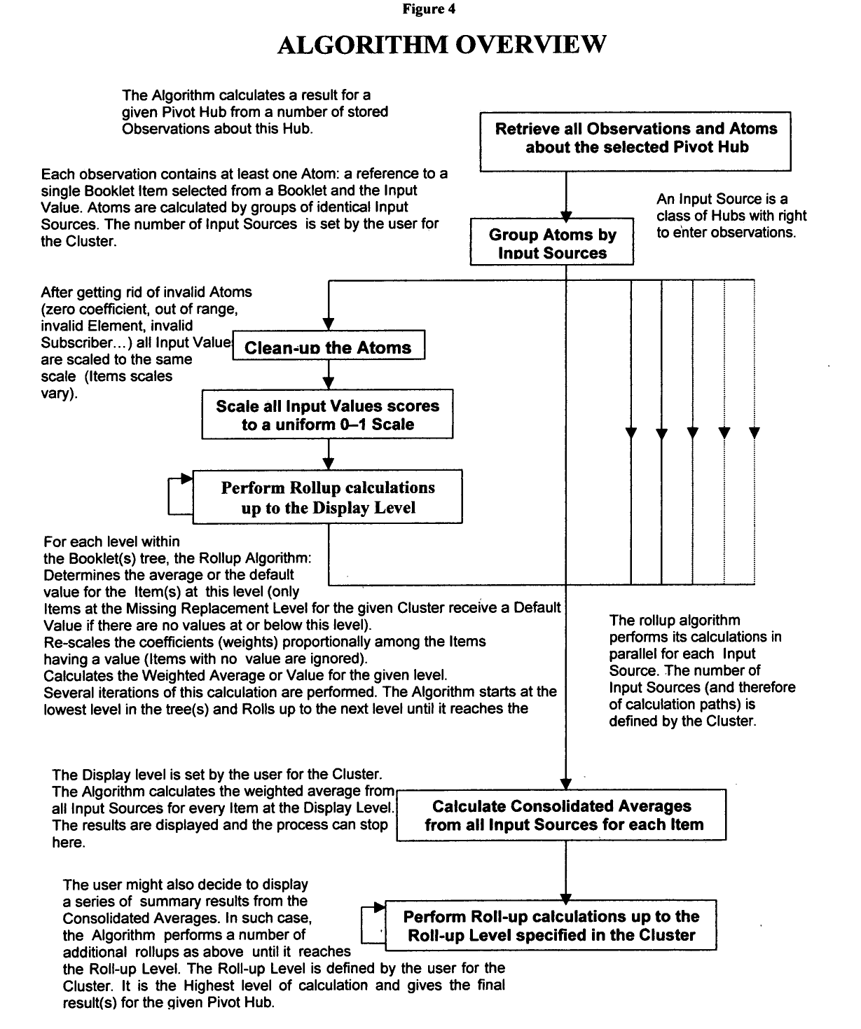

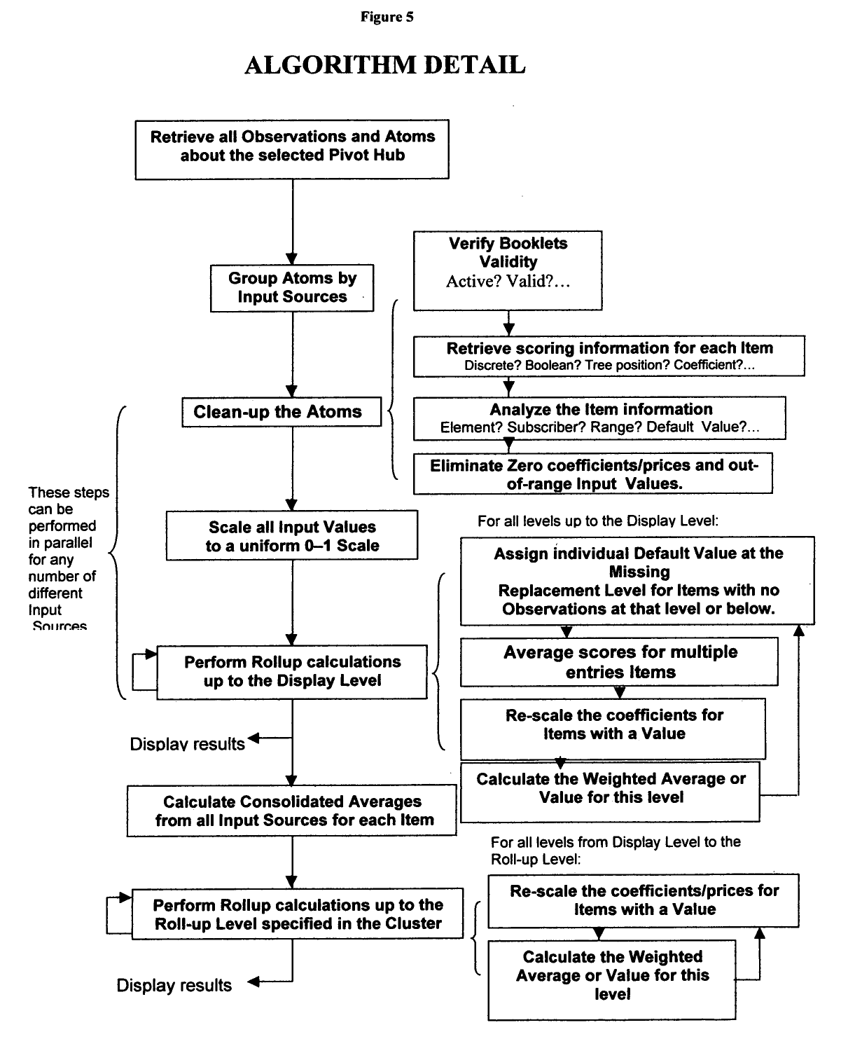

The following is a detailed example of the roll-up algorithm. The overall steps discussed below are shown in FIG. 4, with details being added in FIG. 5.

The following discussion is a simple example of a roll-up calculation as used in the algorithm of the invention. In this example, the application cluster has two booklets about its pivot hub, the first booklet being assigned a weight of 0.4 and the second booklet a weight of 0.6. Within booklet 1, booklet item 1 (at level 1) contains booklet item 2 (at level 2), which further contains booklet items 3-5 (at level 3) and booklet item 6 (at level 2), which further contains booklet items 7-8 (level 3). Booklet item 9 is at level 1 within booklet 1. Within booklet 2, booklet item 10 (level 1) contains booklet items 11-12 (level 2). This structure of these two booklets may be diagrammed as follows:

Booklet 1

Booklet item 1

Booklet item 2

Booklet item 3
Booklet item 4
Booklet item 5

Booklet item 6

Booklet item 7
Booklet item 8

Booklet item 9

Booklet 2

Booklet item 10

Booklet item 11
Booklet item 12

To perform the analysis of the application cluster, all observations about booklet items that have been entered into the system by authorized persons (source) are first retrieved from a data source. For example, in a performance appraisal application cluster, all the observations (called performance notes in this cluster) are retrieved. As previously described, an observation could contain any number of atoms (data elements) that are defined by the booklet item to which they relate and the input value that was entered.

In the following example, ten observations are retrieved from the data source for the time period fixed by the user. For simplicity, each observation contains only one atom with its booklet item and input value as shown in Table 1. Because there are no observations about booklet items 1, 2, 6, 7 and 10, there are no entries for these booklet items in this table.

TABLE 1

| Observation | Input | Booklet | | |
|---|---|---|---|---|
| No. | Value | Item | Booklet | Source |
| 1 | 4 | 4 | 1 | A |
| 2 | 7 | 8 | 1 | A |
| 3 | 5 | 9 | 1 | C |
| 4 | 4 | 5 | 1 | C |
| 5 | 5 | 3 | 1 | C |
| 6 | 4 | 11 | 2 | A |
| 7 | 5 | 12 | 2 | B |
| 8 | 2 | 3 | 1 | C |
| 9 | 5 | 4 | 1 | B |
| 10 | 2 | 5 | 1 | A |

The “source” in the above table is the single individual who entered the observation. Thus A, B, C could be names or employee numbers for example. It can be seen from Table 1 that observation numbers 1 and 9, are from two different sources (A and B), for example, from two different co-workers of an employee, but both relate to booklet item 4. An example of such a situation would be two peers entering an observation about the same job function such as “fires weapons accurately”.

The atoms in the collection are further categorized by input source, which is essentially a grouping of the individual sources, a list of which was established when the application cluster was built or has been accumulating as clients or contributors to the data supply chain are folded into the process. Examples of such input sources are “self”, “direct supervisor”, “assessor”, “client” and the like. For each input source a coefficient and a price or fee may be assigned, based on the weight to be assigned that source's input in the calculations. For example in a performance appraisal cluster, the input from self might be given less weight than the input from supervisors. Table 2 sets forth the two input sources used in the example. In this table, the information is arranged in order of the input sources. Input source 1 is assigned a coefficient or price or fee contribution factor of 0.3 and input source 2 is assigned a coefficient or price or fee contribution factor of 0.7

TABLE 2

| Observation. | Input | Booklet | | | Input |
|---|---|---|---|---|---|
| No. | Value | Item | Booklet | Source | Source |
| 1 | 4 | 4 | 1 | A | 1 |
| 9 | 5 | 4 | 1 | B | 1 |
| 10 | 2 | 5 | 1 | A | 1 |
| 2 | 7 | 8 | 1 | A | 1 |
| 6 | 4 | 11 | 2 | A | 1 |
| 7 | 5 | 12 | 2 | B | 1 |
| 8 | 2 | 3 | 1 | C | 2 |
| 5 | 5 | 3 | 1 | C | 2 |
| 4 | 4 | 5 | 1 | C | 2 |
| 3 | 5 | 9 | 1 | C | 2 |

In this example, sources A and B are both associated with input source 1 and source C is associated with input source 2. If the input source cannot be established for a given observation or is deemed to be invalid in some way or inactive, the atoms contained in that observation are removed from the calculation, which also occurs if the input source has a coefficient of zero. Similarly, if the booklet associated with each atom are not valid or active, or if the booklet has a coefficient of zero, the atom is excluded from the calculations.

Information about booklet items that are associated with the atoms to be used in the calculations is retrieved from the data source. The atom values may be continuous or discrete numeric values, Boolean, multiple-choice, etc. depending on the type of booklet item. Any numeric responses may be used in the calculation process, for example a true/false type of booklet item with two possible responses (e.g., true=1 or false=0). For a response that is a numeric value, the information retrieved would include the range of acceptable values, the coefficient and the default value (if any). The information about each booklet item is then analyzed. Table 3 shows the booklet item information that is retrieved for the observations given in Tables 1-2, including the level in the tree where the booklet item appears, the range of acceptable values, the coefficient (including the proportional price or fee contribution factor) assigned to that booklet item, and the assigned default value of that booklet item. In addition, Table 3 indicates the element associated with each booklet item (arbitrarily assigned a letter A-L). Note that in this example, all of the booklet items have ranges of 1-5, except booklet item 8, which has a range of 1-9. Also note that booklet item 9 was not assigned a default value.

TABLE 3

| | Booklet | | | | | Default |
|---|---|---|---|---|---|---|
| Booklet | item | Level | Element | Range | Coefficient | value |
| 1 | 1 | 1 | A | 1-5 | 1 | 3 |
| 1 | 2 | 2 | B | 1-5 | 1 | 3 |
| 1 | 3 | 3 | C | 1-5 | 0.4 | 3 |
| 1 | 4 | 3 | D | 1-5 | 0.3 | 3 |
| 1 | 5 | 3 | E | 1-5 | 0.2 | 3 |
| 1 | 6 | 2 | F | 1-5 | 1 | 3 |
| 1 | 7 | 3 | G | 1-5 | 1 | 3 |
| 1 | 8 | 3 | H | 1-9 | 1 | 5 |
| 1 | 9 | 1 | I | 1-5 | 1 | None |
| 2 | 10 | 1 | J | 1-5 | 1 | 4 |
| 2 | 11 | 2 | K | 1-5 | 0.6 | 3 |
| 2 | 12 | 2 | L | 1-5 | 0.4 | 3 |

The computer readable code verifies that the element associated with each booklet item exists and is valid for the subscriber or client. The computer readable code also verifies that the booklet item coefficient is not zero and that the input value satisfies the conditions, such as range, specified for this booklet item; otherwise the associated atom is excluded from calculations. Normally, this process would exclude very few atoms.

Because the range of values specified is not necessarily the same for all booklet items, and because different booklet items may have different types of response, all atom values are scaled on a range from 0 to 1, and all calculations are done on this scaled value. Scaled values for input sources 1 and 2 are shown in Tables 4a and 4b, respectively.

TABLE 4a
Input Source 1

| | | | Scaled | Booklet | | |
|---|---|---|---|---|---|---|
| No. | Value | Range | Value | item | Booklet | Source |
| 1 | 4 | 1-5 | 0.75 | 4 | 1 | A |
| 9 | 5 | 1-5 | 1.0 | 4 | 1 | B |
| 10 | 2 | 1-5 | 0.25 | 5 | 1 | A |
| 2 | 7 | 1-9 | 0.75 | 8 | 1 | A |
| 6 | 4 | 1-5 | 0.75 | 11 | 2 | A |
| 7 | 5 | 1-5 | 1.0 | 12 | 2 | B |

TABLE 4b
Input Source 2

| | | | Scaled | Booklet | | |
|---|---|---|---|---|---|---|
| No. | Value | Range | Value | Item | Booklet | Source |
| 8 | 2 | 1-5 | 0.25 | 3 | 1 | C |
| 5 | 5 | 1-5 | 1.0 | 3 | 1 | C |
| 4 | 4 | 1-5 | 0.75 | 5 | 1 | C |
| 3 | 5 | 1-5 | 1.0 | 9 | 1 | C |

Not shown above are the booklet items for which there were no observation retrieved, for example, booklet item 9, input source 1, and booklet item 10, input source 2.

The default value initially assigned by the subscriber to each booklet item is entered for booklet items that are at the missing replacement level (see definition above) and for which no observations are retrieved at that level or below. The missing value replacement level was set when the application cluster is designed. A missing value replacement level of “1” replaces missing values (no observation retrieved for the booklet item or below) with the default value only at level 1 in the booklets. A missing value replacement level of “3” replaces missing values with the default value at level 3 in the booklets. If a default value has not been assigned to the booklet item information, the cluster value (see definition above) is used (set by the client at the cluster level). The cluster default can be the mid-range if such a value is considered a typical score, or may be any other value as is appropriate for the application, cluster (e.g., in biological research if there is no observation, an appropriate default value would be likely to be zero), or as is considered useful for the particular application.

The example uses a missing replacement level of 1. Table 5 shows only the level 1 booklet items (booklet items 9 and 10) for which there is no observation (for booklet item 9, input source 1; and for booklet item 10, input source 2).

TABLE 5

| Missing value | | | | |
|---|---|---|---|---|
| replacement | Scaled Value | Booklet item | Booklet | Input Source |
| 3 | 0.5 | 9 | 1 | 1 |
| 4 | 0.75 | 10 | 2 | 2 |

Note that since booklet item 9 does not have a default value assigned to it, the cluster value is used for replacement, which is 3 in this example. For booklet items that have more than one observation retrieved (in the example, booklet item 4 and booklet item 3), the average of all of the scaled input values for that item are calculated. The resultant averages for these booklet items are shown in Table 6.

TABLE 6

| | | Values averaged | Scaled |
|---|---|---|---|
| Booklet item | Input Source | (scaled value) | Average |
| 4 | 1 | 4 (0.75) & 5 (1.0) | 0.875 |
| 3 | 2 | 2 (0.25) & 5 (1.0) | 0.625 |

Next, the coefficients for all level 3 items that have an input value are scaled to a 0 to 1 scale so that the sum of these coefficients equals 1. This process redistributes the weights among the items that have an input value and ignores all items for which no observation was retrieved. Thus, if booklet items 3-5 are at level 3 and have original coefficients of 0.4, 0.3 and 0.2 respectively, and if booklet item 3 is ignored because no observation is retrieved for that item, the scaled coefficients for booklet items 4 and 5 will be 0.6 and 0.4, respectively. Similarly, if the coefficients for booklet items 7 and 8 are each 1.0 but booklet item 7 is ignored, the scaled coefficient of booklet item 8 will remain 1.0. The scaled coefficients for level 3 items in the example herein are thus shown in Tables 7a and 7b for input Sources 1 and 2, respectively.

TABLE 7
Input source 1

| Booklet items | | | | Scaled |
|---|---|---|---|---|
| scaled together | Booklet item | Ignored? | Coefficient | Coefficient |
| 3, 4, 5 | 3 | Yes | 0.4 | N/A |
| 3, 4, 5 | 4 | No | 0.3 | 0.6 |
| 3, 4, 5 | 5 | No | 0.2 | 0.4 |
| 7, 8 | 7 | Yes | 1.0 | N/A |
| 7, 8 | 8 | No | 1.0 | 1.0 |

TABLE 7
Input source 2

| Booklet items | | | | Scaled |
|---|---|---|---|---|
| scaled together | Booklet item | Ignored? | Coefficient | Coefficient |
| 3, 4, 5 | 3 | No | 0.4 | 0.667 |
| 3, 4, 5 | 4 | Yes | 0.3 | N/A |
| 3, 4, 5 | 5 | No | 0.2 | 0.333 |

The roll-up of level three values to level two is shown in Table 8. The scaled averages or scaled value and the scaled coefficients for the level three items are used. If a booklet item does not have a scaled average or an input value, it is ignored in the calculations. For booklet items 4 and 5, the scaled average or scaled value, respectively, was multiplied times the scaled coefficient, and the products added together to form the roll-up level two value. Similar calculations are done for the remaining level 3 booklet items.

TABLE 8a
Input source 1

| | | Roll-up |
|---|---|---|
| | | level 2 |
| | | value |
| Booklet | | (sum of |
| item | Calculation | products) |
| 2 | Booklet item 3: ignore; booklet item 4: the product | 0.625 |
| | of scaled average 0.875 & scaled coefficient 0.6 = | |
| | 0.525; booklet item 5: the product of scaled value | |
| | 0.25 and scaled coefficient 0.4 = 0.1 | |
| 6 | Booklet item 7: ignore; booklet item 8: the product | 0.75 |
| | of scaled value 0.75 and scaled coefficient 1.0 = | |
| | 0.75 | |
| 11, 12 | No calculations required (are terminal modes on tree | N/A |
| | and do not contain level 3 values) | |

TABLE 8b
Input source 2

| | | Roll-up |
|---|---|---|
| | | level 2 |
| | | value |
| Booklet | | (sum of |
| Item | Calculation | products) |
| 2 | Booklet item 3: the product of scaled average 0.625 | 0.6667 |
| | and scaled coefficient 0.6667 = 0.4167; booklet item | |
| | 4: ignore; booklet item 5: the product of scaled | |
| | value 0.75 and scaled coefficient 0.333 = 0.2500 | |
| 6 | No calculations required; no atom values for booklet | N/A |
| | items 7 & 8 | |
| 11, 12 | No calculations required (are terminal modes on tree | N/A |
| | and do not contain level 3 values) | |

After the roll-up to level two is accomplished, the coefficients for all level 2 items that have an input value are scaled as was done for the coefficients for the level 3 items. Results for the example above are shown in Tables 9a and 9b.

TABLE 9a
Input source 1

| Booklet items | | | | Scaled |
|---|---|---|---|---|
| scaled together | Booklet item | Ignored? | Coefficient | Coefficient |
| 2, 6 | 2 | No | 1.0 | 0.5 |
| 2, 6 | 6 | No | 1.0 | 0.5 |
| 11, 12 | 11 | No | 0.6 | 0.6 |
| 11, 12 | 12 | No | 0.4 | 0.4 |

TABLE 9b
Input source 2

| Booklet items | | | | Scaled |
|---|---|---|---|---|
| scaled together | Booklet item | Ignored? | Coefficient | Coefficient |
| 2, 6 | 2 | No | 1.0 | 1.0 |
| 2, 6 | 6 | Yes | 1.0 | N/A |
| 11, 12 | 11 | Yes | 0.6 | N/A |
| 11, 12 | 12 | Yes | 0.4 | N/A |

After this, the level two values are rolled up to level one using the weighted average and the scaled coefficient for the level two items as shown in Tables 10a and 10b. If there is no weighted average, the input value is used. If a booklet item does not have a weighted average or an input value, it is ignored in the calculations.

TABLE 10a
Input source 1

| | | Roll-up |
|---|---|---|
| | | level 1 value |
| Booklet | | (sum of |
| item | Calculation | products) |
| 1 | Booklet item 2: the product of weighted average | 0.6875 |
| | 0.625 and scaled coefficient 0.5 = 0.3125; booklet | |
| | item 6: the product of weighted average 0.75 and | |
| | scaled coefficient 0.5 = 0.375 | |
| 9 | This is a terminal mode of the tree; scaled | 0.5 |
| | value = 0.5 | |
| 10 | Booklet item 11: the product of the scaled | 0.85 |
| | value 0.75 and scaled coefficient 0.6 = 0.45; | |
| | booklet item 12: the product of the scaled value | |
| | 1.0 and the scaled coefficient 0.4 = 0.4 | |

TABLE 10b
Input source 2

| | | Roll-up |
|---|---|---|
| | | level 1 |
| | | value |
| | | (sum of |
| Booklet | | calculated |
| Item | Calculation | products) |
| 1 | Booklet item 2: the product of weighted average | 0.6667 |
| | 0.6667 and scaled coefficient 1.0 = 0.6667; booklet | |
| | item 6: ignored (no weighted average) | |
| 9 | This is a terminal mode of the tree; scaled | 1.0 |
| | value = 1.0 | |
| 10 | No atom values for booklet items 11 and 12; scaled | 0.75 |
| | value for booklet item 10 = 0.75 | |

At this point, the calculations have reached level 1, which is the selected display level in this example (the level at which the client wishes to consolidate the data from all input sources, see definition above). The consolidated average for each level one booklet item is then calculated. This calculation merges all the sources of input into a single result for each level one booklet item. The weighted averages for the level one items and the coefficients for each source of input are used. The consolidated average results for this example are shown in Table 11 for booklet items 1, 9 and 10, which are each at level 1.

TABLE 11

| | Input | Input | |
|---|---|---|---|
| | source 1 | source 2 | |
| Booklet | averages | averages | |
| item | (weight 0.3) | (weight 0.7) | Consolidated average |
| 1 | 0.6875 | 0.6667 | (0.6875)(0.3) + (0.6667)(0.7) = |
| | | | 0.6729 |
| 9 | 0.5 | 1.0 | (0.5)(0.3) + (1.0)(0.7) = 0.85 |
| 10 | 0.85 | 0.75 | (0.85)(0.3) + (0.75)(0.7) = 0.78 |

After the roll-up to level one is accomplished, the coefficients for all level 1 items that have an input value or a missing replacement value (since the missing replacement value in this example was set at level 1) are scaled as was done for the coefficients for the level 2 and level 3 booklet items. Results for the example above are shown in Table 12.

TABLE 12

| Booklet items | | | Scaled |
|---|---|---|---|
| scaled together | Booklet item | Coefficient | coefficient |
| 1, 9 | 1 | 1.0 | 0.5 |
| 1, 9 | 9 | 1.0 | 0.5 |
| 10 | 10 | 1.0 | 1.0 |

The level 1 values are rolled up to level 0 (the booklet level). The consolidated averages and the scaled coefficient for the level 1 items are used. Results for the example are shown in Table 13.

TABLE 13

| | | Roll-up |
|---|---|---|
| | | booklet (sum |
| Booklet | Calculation | of products) |
| 1 | Booklet item 1: the product of | 0.7615 |
| | consolidated average 0.6729 and scaled | |
| | coefficient 0.5 = 0.3365; booklet item 9: | |
| | the product of consolidated average 0.85 | |
| | and scaled coefficient 0.5 = 0.425 | |
| 2 | Booklet item 10: product of weighted | 0.78 |
| | average 0.78 and scaled coefficient 1.0 = | |
| | 0.78 | |

Finally, the roll-up level (level “−1” in this example) value from all booklets is calculated as shown in Table 14.

TABLE 14

| | | Final Roll-up |
|---|---|---|
| | | value (sum |
| | | of calculated |
| Booklets | Calculation | products) |
| 1, 2 | Booklet 1: product of roll-up booklet 1 0.7615 | 0.7726 |
| | and booklet 1 coefficient 0.4 = 0.3046; booklet | |
| | 2: product of roll-up booklet 2 10.78 and | |
| | booklet 2 coefficient 0.6 = 0.468 | |

In the case of a performance appraisal application cluster, this result would represent the score of the employee on the appraisal. This information can be used comparatively to determine pay increases among a pool of employees, to determine standards against which to compare year to year performance for the employee, to keep the employee apprised of current performance ratings, to provide a benchmark for like positions across a group of employers using the same booklets for the position, to track which supervisors or peers are monitoring performance, to compare rating patterns across departmental divisions or units, to identify outlier observations or outlier input sources, and so forth.

In a quality control application cluster, this result would represent for the manager the final quality score for a set of quality measures contained in quality booklets about a particular manufacturing process for a pre-defined product. In that case the data might be input by inspectors, customers, employees and other input sources. A subscriber or client to a quality control application cluster might set target results, compare results, run the algorithm for different roll-up and display levels to identify which booklet item (and therefore which element) in a booklet is worth monitoring because it significantly impacts the results, which input source is worth training or requiring input from to improve the quality or quantity of the inputs, which elements proportionately impact the final quality score/result, what pattern of quality observation are being made, and many other questions related to the interest of a user to that application cluster.

While the invention has been described with reference to specific embodiments, it will be appreciated that the design of the invention makes numerous variations, modifications, and embodiments possible, and accordingly, all such variations, modifications, and embodiments are to be regarded as being within the spirit and scope of the invention.

What is claimed is:

1. An information handling process to implement pricing and weighting and other calculations within a federated data source or a data supply chain to shape and propagate research designs composed of hubs, relationships between hubs, booklets that include lists of booklets items that are linked to researchable elements and root elements, and a calculation algorithm, said research design being configurable to suit any research or business process or plurality of research and business processes through an application cluster or a plurality of application clusters.

2. The research designs of claim 1, wherein said information handling process enables continuous, discontinuous or sporadic accumulation of observations from data sources by a user of the process, each of which observation includes an atom or a plurality of atoms, about one or a plurality of booklet items from one or a plurality of input sources, said atom or plurality of atoms being correlated insofar as the booklet items refer to identical elements or root elements, enabling research to be performed across one or a plurality of application clusters and across industries, business processes, and research protocols.

3. The information handling process of claim 1, wherein each application cluster or plurality of application clusters provides specifications for the behavior of the information handling system when operating on information related to that application cluster or a plurality of application clusters, and to each booklet or plurality of booklets used within an applicable application cluster.

4. The information handling process of claim 1 and the research design of claim 2, wherein atoms related to booklet items within one application cluster may be used by another application cluster if the application clusters each use booklet items related to identical elements or root elements.

5. An information handling process for use with observations, comprising:
a) defining one or more booklets in a first level, each of said booklets comprising one or more booklet items in a second level and having a defined weight or price or value;
b) defining one or a plurality of input sources, each of said input sources having a defined weight or price or value;
c) providing an opportunity for one or more atoms of each observation to be collected from said input sources, and assigning the collected atoms to related booklet items;
d) analyzing the atoms for validity;
e) determining an actual value for each collected atom;
f) determining a scaled value for each atom based on a possible range of values for the atom and the actual value of the atom;
g) determining at which level default values are to be entered for missing values;
h) entering a missing replacement value at the determined level where there are no observations;
i) for booklet items containing one or more atoms, enabling an option for a user to set one or both methods of averaging the scaled values to result in a scaled average or averaging the scaled values to store the atom as a data point or price or value or weight a combination of data point price or value or weight within a data source;
j) determining a roll-up value or price or weight or a combination of a value or price or weight for the first level; and
k) utilizing the roll-up calculations for the first level to determine a price or weight or value or a combination of price or weight or value to associate with each booklet.

6. The information handling process according to claim 5, further comprising using the price or weight or value or a combination of price or weight or value to associate with each booklet and the assigned weight or price or value of the contribution of the booklet to determine a roll-up calculation or plurality of calculations of a value, weight or prices or a combination of values, prices and weights for the booklets; and utilizing the roll-up value for the booklets to determine a summary level roll-up price or weight or value or a combination of values, prices and weights.

7. The information handling process according to claim 5, wherein one or more of said booklet items in said second level comprises one or more booklet items in a third level, each of said booklet items having a value or weight or price or a combination of values weights and prices, and further comprising determining a roll-up value or weight or price or a combination of values weights and prices for the second level prior to determining the roll-up value for the first level.

8. The information handling process according to claim 5, wherein one or more of the observations comprise a plurality of atoms of information.

9. The information handling process according to claim 5, wherein the observations are collected by more than one input source, and wherein the observations are grouped by input source.

10. The information handling process according to claim 5, wherein the observations are attached to a root element
a) through marking or attaching a correlation coefficient or price or value or a combination of price weight and value
b) setting a roll-up level for calculating whether a trigger value has been reached
c) defining a trigger value for appending additional booklet items
d) setting a number of booklet items to be appended if a trigger value has been reached

11. The information handling process according to claim 5 wherein additional root elements are selected for research through the accumulation of observations that reach trigger values.

12. The research design according to claim 2, related to an application cluster, comprising:
a) providing at least one booklet in the application cluster;
b) providing booklet items related to said booklets, each of said booklets items at a defined position and level in a booklet;
c) providing a hub that may serve as a source or target of observations within said application cluster;
d) attaching said booklets to said hub; and
e) determining ranges, coefficients, prices, weights, default values, and other calculation specifications (higher level input value), and input specifications to be assigned to the booklet items;
f) obtaining atoms of information from observations related to said application cluster, each of said atoms having a specified input value;
g) relating each of the atoms to a particular booklet item;
h) utilizing the relationship between the atoms, booklet items and booklets, the input values of the atoms, and the ranges, coefficients and prices and weights and default values assigned to the booklet items to determine scaled averages and scaled coefficients and prices at the lowest defined booklet item level;
i) utilizing the scaled averages and the scaled coefficients of the lowest defined booklet item level, rolling up to the next lowest booklet item level, if any, to yield scaled averages and scaled coefficients and prices at the next to lowest booklet item level, or if there is no remaining next lowest booklet item level, rolling up to the booklet; and
j) repeating steps h) and i) until the highest booklet item level is reached.

13. A research design according to claim 2, for handling information that comprises observations, said design comprising the following interrelated components:
a) one or more application clusters;
b) one or more booklets;
c) one or more booklet items; and
d) one or more atoms, each atom recording one or a plurality of input values, weights or prices in an observation;
wherein:
a) each application cluster comprises at least one booklet;
b) each booklet comprises at least one booklet item;
c) each atom is related to a booklet item;
wherein the relationship between each atom and its related booklet item specifies the means for the information handling system to interpret the meaning of the value in the atom, so that the information handling system can correlate all atoms related to the same booklet item and can identify the booklet item associated with each atom.
d) each booklet item is correlated with a root element.

14. The information handling system of claim 7, wherein booklet items in different booklets and with observations from disparate, apparently unrelated sources may be correlated insofar as the booklet items refer to identical elements;

15. The information handling system of claim 7, wherein each of which application clusters provides specifications for the behavior of the information handling system when operating on information related to that application cluster, and to each booklet contained within the application cluster.

16. The information handling system of claim 7, wherein atoms related to booklet items within one application cluster may be used for another application cluster if the application clusters each use booklet items related to identical root elements. The information handling system of claim 13, wherein booklet items within a particular booklet are related to each other and to the particular booklet in a hierarchical structure, wherein information in the booklet items in the hierarchical structure can be rolled up to provide data about the booklet.

17. The information handling system of claim 14, wherein one or a plurality of booklets are related to each other in one or a plurality of application clusters that may be arranged into an hierarchical structure and can be rolled up to provide information about the application cluster or hub.

18. The information handling system of claim 15, wherein one or a plurality of application clusters are related to each other in one or a plurality of business processes or research domains that may be arranged into an hierarchical structure and can be rolled up to provide information about the hub category or business process or research domain.
